(19) United States
(12) Patent Application Publication
(10) Pub. No.: US 2006/0001356 A1
(43) Pub. Date: Jan. 5, 2006

(54) FED including gate-supporting device with gate mask having reflection layer

(75) Inventors: Te-Fong Chan, Taipei (TW); Kuei-Wen Cheng, Taipei (TW)

Correspondence Address: TROXELL LAW OFFICE PLLC;SUITE 1404, 5205 LEESBURG PIKE, FALLS CHURCH, VA, 22041, US

(73) Assignee: Teco Nanotech Co., Ltd.

(21) Appl. No.: 10/879,020

(22) Filed: Jun. 30, 2004

(51) Int. Cl. H01J 1/88; H01J 1/62; H01J 63/04; H01J 19/42

(52) U.S. Cl. 313/495; 313/496; 313/292

(57) ABSTRACT

An FED has a cathode with a plurality of cathode electron emitter layers and a cathode substrate, an anode having a phosphors layer and an anode substrate, and supporting device. The cathode includes a plurality of cathode ribs disposed on the cathode substrate, and the cathode ribs are used for laterally separating any respective two cathodes ribs. The cathode has a gate made from a metallic mask and disposed above the cathode ribs. The supporting device is arranged between the metallic mask and the anode, and has a reflection layer facing the anode. The reflection layer is capable of reflecting light emitted from the phosphors layer.

### BACKGROUND OF THE INVENTION

1. Field of the Invention

The present invention relates to a FED, and particularly relates to an FED including a gate-supporting device with a gate mask that has a reflection layer.

2. Background of the Invention

There are several categories of a flat panel display (FPD), such as, for example a field emission display (FED), a thin film transistor-liquid crystal display (TFT-LCD), a plasma display panel (PDP), an organic electro-luminescence display (OELD), or a reflection-type liquid crystal display (LCD). Thinness, lightness, low power consumption, and portability are the common features of the FPDs mentioned above. The FED has many similarities to conventional cathode ray tubes (CRT). As for the CRT, electrons are accelerated in a vacuum towards phosphors, which then glows. The main difference from the CRT is that the electrons are generated by field emission rather than thermal emission, so the device consumes much less power and can be turned on instantly. Instead of one single electron gun, each pixel includes several thousand sub-micrometer or even nanometer tips from which electrons are emitted. The tips, made of low work-function materials, in particular of carbon nanotubes (CNTs) nowadays, are sharp, so that the local field strengths are high enough for even a moderately low gate voltage.

A conventional FED illustrated in FIG. 1 includes a unit within an anode 10a and a cathode 20a disposed therein, and an insulating supporting member 15a (or a spacer) arranged between the anode 10a and the cathode 20a for separating the anode 10a from the cathode 10a and supporting the anode 10a. The anode 10a includes an anode glass substrate 11a, an anode conductive layer 12a, and a phosphors layer 13a arranged sequentially. The cathode 20a includes a cathode glass substrate 21a, a cathode electrode layer 22a, a cathode electron emitter layer 23a, a dielectric layer 24a, and a gate layer 25a arranged sequentially. The insulating supporting member 15a is connected between the anode 10a and the cathode 10a to provide support. The cathode electron emitter layer 13a generates electrons for emission onto the phosphors layer 13a to produce light via an additional electric field, so as to excite the phosphors layer 13a to luminesce. Furthermore, the cathode electrode layer 22a is made from cathode conductive lines parallel to one another, and the gate layer 25a is made from gate conductive lines parallel to one another. The gate conductive lines are orthogonal to the cathode conductive lines. In addition, an additional voltage is forced between the gate layer 25a and the cathode electrode layer 22a. An electron beam provided by the gate layer is controlled to switch due to the orthogonal arrangement between the gate conductive lines and the cathode conductive lines. For ease in moving the electrons, a vacuum of 10⁻⁷ Torr is accordingly formed therein, a mean free path of the electrons is provided, and, furthermore, the vacuum can protect the cathode electron emitter layer 23a and the phosphors layer 13a from pollution. In order to accelerate the electrons for impact, there should be a proper distance between the anode 10a and the cathode 20a; after the anode 10a is provided with high power, the electron beam is energized enough to excite the phosphors.

A photolithographic method can be adopted for the conventional FED, but is still hard to mass-produce due to the complicated procedures and the precise fabrications. FIG. 2 shows a gate mask 46′ applied thereto, and FIG. 3 shows the gate mask 46′ arranged in an FED to replace the photolithographic method. The gate mask 46′ can be seen as an independent element disposed between the cathode 2′ and the anode 1′; a dielectric rib 24′ is supported between the cathode 2′ and the anode 1′. A vacuum cavity is formed thereby. The gate mask 46′ usually has a thickness of 50 μm to 200 μm and is laminated from a plurality of sheets with gate conductive lines. An effect of the resonance due to the gate mask can influence the display quality of the FED.

In recent years, a new insulating supporting member is shaped from a panel as a rib, referring to FIG. 11. An expansion coefficient of this material is similar to that of glass. The thickness of the plate-like device ranges from 500 μm to 1500 μm, and the plate-like device has a plurality of apertures 42′ etched therein. A diameter of each aperture 42′ matches the FED unit (including the anode and the cathode). The plate-like device is used for a support. The conventional supporting member is shaped as a glass ball, a cross, or a strip via an adhesive stuck thereto in advance. After a sintering process, a plate-like device is made thereby. The plate-like device has a size ranging from 50 μm to 200 μm. Because of the micro size, the plate-like device has some problems in manufacture. First, the plate-like device is complicated to manufacture; the equipment needs more precision due to the micro size. Second, the plate-like device sticky with the adhesive is polluted easily; because the conventional plate-like device uses adhesive to connect to a panel and a sintering process is required, the adhesive easily pollutes the panel. Third, after the sintering process, the solvent contained in the adhesive will escape therefrom to pollute the panel.

Hence, an improvement over the prior art is required to overcome the disadvantages thereof.

### SUMMARY OF INVENTION

The primary object of the invention is therefore to specify an FED that includes a gate-supporting device with a reflection layer, where the gate-supporting device is combined with a gate mask.

The secondary object of the invention is therefore to specify an FED of which the gate-supporting device is manufactured individually to save cost.

The third object of the invention is therefore to specify an FED for which the elements individually manufactured in advance are assembled in simple steps.

These objects are achieved by an FED that includes a cathode having a plurality of cathode electron emitter layers and a cathode substrate, an anode having a phosphors layer and an anode substrate, and supporting device. The cathode includes a plurality of cathode ribs disposed on the cathode substrate, and the cathode ribs are used for laterally separating any respective two cathodes ribs. The cathode includes a gate made from a metallic mask and disposed above the cathode ribs. The supporting device is arranged between the metallic mask and the anode, and has a reflection layer towards the anode. The reflection layer is capable of reflecting the light emitted from the phosphors layer.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a cross-sectional profile of a conventional FED;

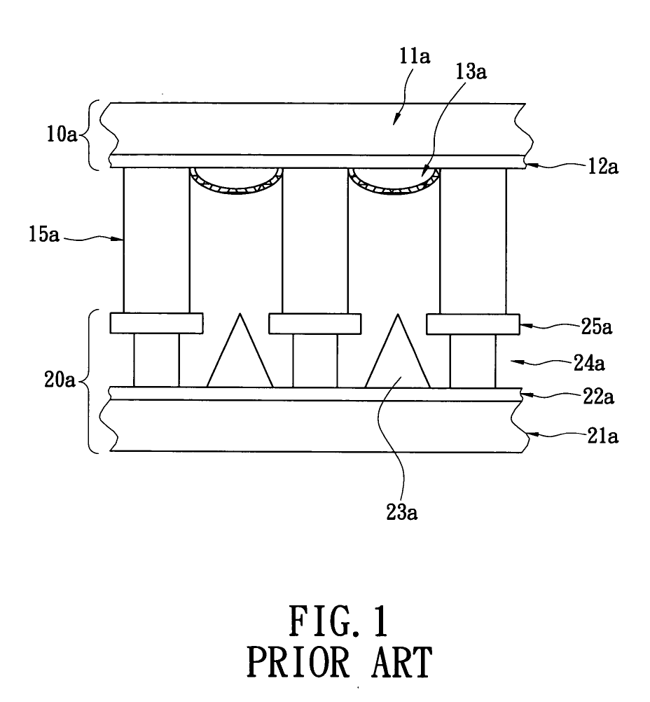

FIG. 2 is a perspective view of a conventional gate mask;

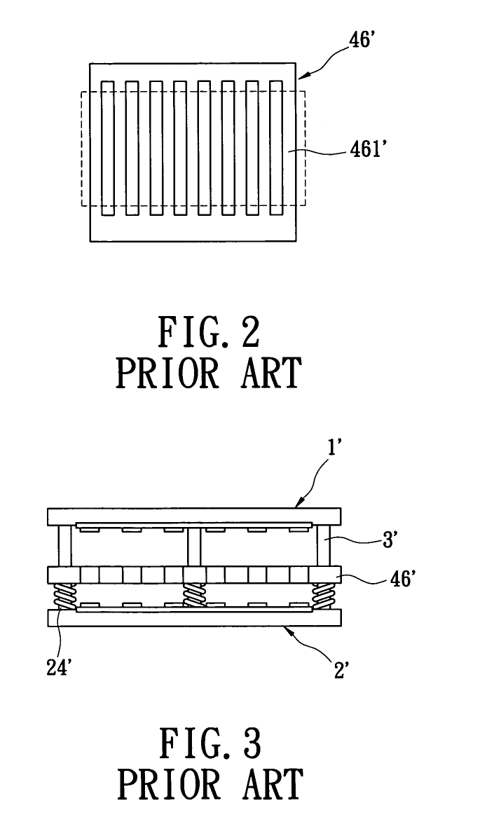

FIG. 3 is a perspective view of a conventional FED with a conventional gate mask;

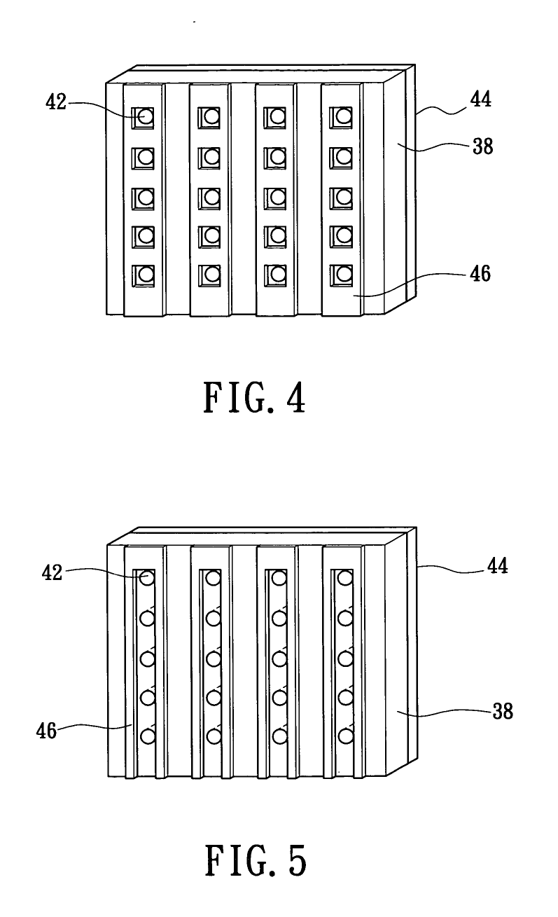

FIGS. 4 to 6 are perspective views of a supporting device with a reflection layer and a gate according to the present invention;

FIGS. 7 to 9 are perspective views-of three embodiments of a gate mask;

FIG. 10 is a perspective view of the FED according to the present invention; and FIG. 11 is a perspective view of the supporting device.

### DETAILED DESCRIPTION OF THE EMBODIMENTS

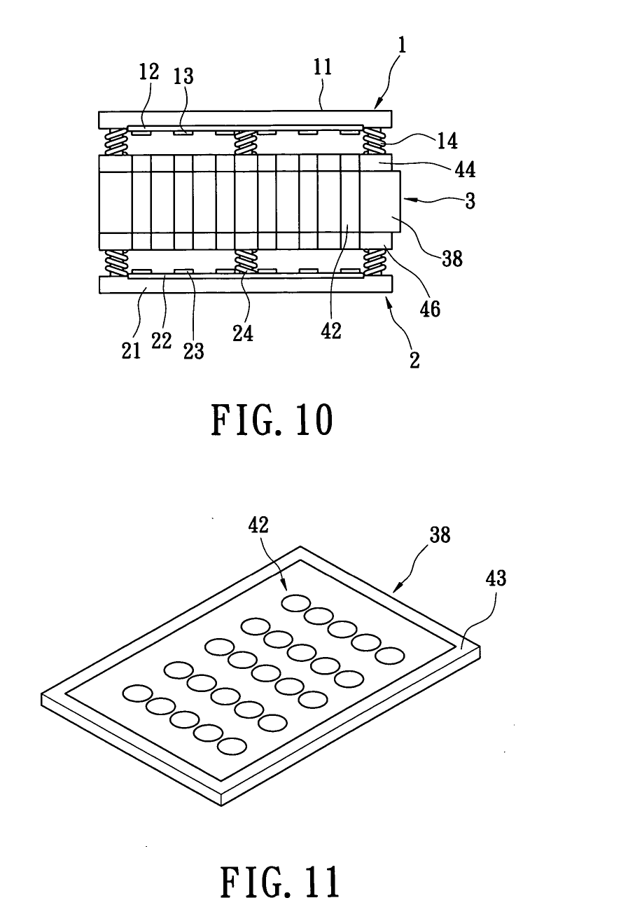

FIG. 10 shows an FED that includes a cathode 2, an anode 1 and a supporting device 38. The cathode 2 has a plurality of cathode ribs 24, a plurality of cathode electron emitter layers 23, a cathode electrode layer 22 and a cathode glass substrate 21. The anode 1 has a plurality of anode ribs 14, an anode conductive layer 12, a phosphors layer 13 and an anode substrate 11. The supporting device 38 has a reflection layer 44. The cathode ribs 24 are arranged over the cathode substrate 21, and adjacent to a gate 46 of the supporting device 38. The cathode ribs 24 are alternately arranged with the cathode electron emitter layers 23. The thickness of each of the cathode ribs 24 is a factor in determining an additional field over the gate 46 and the cathode electrode layer 22 and controlling the capacity of electrons emitted from the cathode electron emitter layers 23 by the gate 46. The cathode ribs 24 replace the conventional dielectric layer 24a.

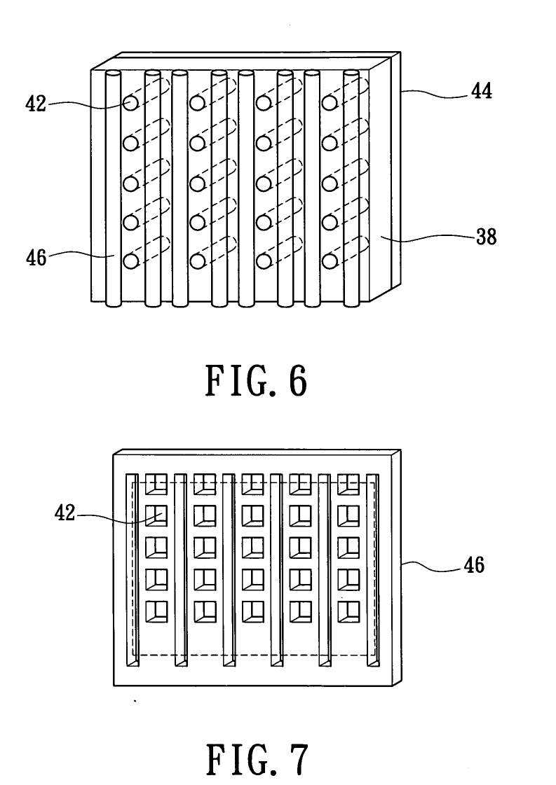

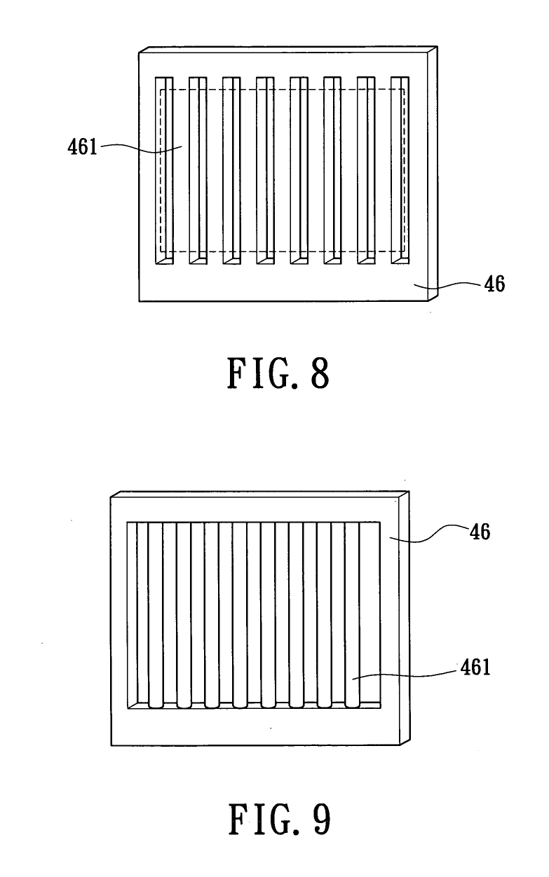

With respect to FIGS. 4 to 6, the supporting device 38 includes a plurality of apertures 42 formed therein. The supporting device 38 is used to support the cathode 2 and the anode 1, and the apertures 42 provide a cavity for relative electrons. The supporting device 38 is made of insulating materials, and the reflection layer 44 is arranged on a side of the supporting device 38 to correspond to the anode for light reflection. The luminance is increased thereby, and a periphery surrounding the reflection layer is an ineffective area used for sealing and alignment. The gate 46 is arranged on an opposite side of the supporting device 38. The gate 46 is made from gate conductive lines 461. A first type of the gate 46 is made of a metallic mask after the etching process; the gate conductive lines include a plurality of holes relating to through holes of the supporting device 38. The gate conductive lines are parallel to one another and orthogonal to the cathode conductive lines of the cathode electrode layer 22. The cathode conductive lines of the cathode electrode layer 22 are parallel to one another. FIG. 4 shows a second type of the gate 46 made of a metallic mask after etching process, too. Any two of the gate conductive lines is taken as a line unit, and an aperture is formed in the line unit. The aperture corresponds to a respective one of the through holes of the supporting device 38. The line unit is orthogonal to the cathode conductive lines of the cathode electrode layer 22. FIG. 5 illustrates a third type of the gate 46, a plurality of metallic lines parallel to one another, where any two of the gate conductive lines are a line unit, and an aperture is formed in the line unit, too. The aperture corresponds to a respective one of the through holes of the supporting device 38. The line unit is orthogonal to the cathode conductive lines of the cathode electrode layer 22. The anode ribs 14 relates to the apertures 42 as a plurality of passageways formed between the anode ribs 14 and communicating with the apertures 42, respectively. The reflection layer of the supporting device 38 can be made of a glass substrate with apertures 42 by sputtering or evaporation. The gate mask contacts the opposite side of the glass substrate. A gate mask before cutting is shown in FIGS. 7 to 9. Materials with similar expansion coefficients are applicable to the supporting device 38 and the gate mask. The gate mask is divided into an effective contact area and an ineffective removable area. The effective contact area of the gate mask is used easily via a glass glue for connection and supports the support device 38. A semi-product with the gate conductive lines can be sliced to remove the ineffective area for the gate conductive lines individually.

The steps of the making the FED includes making a plurality of cathode ribs 24 and anode ribs 14, respectively disposed on the cathode electron emitter layer 23 of the cathode 20 and the phosphors layer 13 of the anode 10. The cathode ribs 24 and the anode ribs. 14 are arranged between the reflection layer 44 and the gate 46 and adjacent to the apertures 42. Glue (UV glue) and a binder are applied to a predetermined position of the ineffective area 43 (see FIG. 11) to false-connect the supporting device 38 between the cathode 2 and the anode 1. After a sintering process, the UV glue can be removed due to the oxidization, or the binder can be hardened to secure the supporting device 38. The supporting device 38 can be aligned with precision. The unit of the anode 1 and the cathode 2 can align with the apertures. The false-connect process or clamping equipment can be adopted. The semi-product after false connection is then sintered in order to secure the supporting device 38 between the anode 1 and the cathode 2.

The materials with similar expansion coefficients will increase the precision of the alignment between the supporting device 38 and the gate 46. Furthermore, the similar expansion coefficients of these materials helps the alignment between the cathode 2 and the anode 1.

For further detailed descriptions, the reflection layer 44 faces the phosphors layer 11. The phosphors layer 11 is processed in a screen-printing manner or a spreading manner. The cathode electron emitter layers 23 are processed in a screen-printing manner or a spreading manner. Each of the cathode electron emitter layers 23 includes a plurality of property-improving carbon nanotubes (like dotting carbon nanotubes) and is capable of high electron emission efficiency. The supporting device 38 has a plurality of apertures 42 formed on the reflection layer 44, and each of the cathode electron emitter layers is formed on each of the apertures 42. The reflection layer is made of aluminum or chromium. The cathode ribs 24 and the anode ribs 14 are fabricated by photolithography or screen-printing. An adhesive with glass is provided and is capable of connecting the anode 1 and the cathode 2 after a sintering process. The metallic mask 46 has an expansion coefficient ranging from 10⁻⁶ to 10⁻⁷ per degree centigrade. The metallic mask 46 has a thickness ranging from 50 μm to 100 μm. Each of the anode ribs 14 has a thickness ranging from 50 μm to 100 μm, and each of the cathode ribs 24 has a thickness ranging from 30 μm to 60 μm. The metallic mask 46 is made of ferro-nickel alloy materials. The supporting device 38 has an expansion coefficient ranging from 82×10⁻⁶ to 86×10⁻⁷ per degree centigrade. The driving power is designed as 80 voltages.

The present invention is characterized by an easy manufacturing process, mass production, low costs and less equipment.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An FED comprising:
a cathode having a plurality of cathode electron emitter layers and a cathode substrate, wherein the cathode includes a plurality of cathode ribs disposed on the cathode substrate, and the cathode ribs- are used for laterally separating any respective two of the cathodes ribs, and wherein the cathode includes a gate made from a metallic mask and disposed above the cathode ribs;
an anode having a phosphors layer and an anode substrate; and
a supporting device arranged between the metallic mask and the anode, and having a reflection layer facing the anode, wherein the reflection layer is capable of reflecting light emitted from the phosphors layer.

2. The FED as claimed in claim 1, wherein the reflection layer faces the phosphors layer.

3. The FED as claimed in claim 1, wherein the phosphors layer is processed in a screen-printing manner or a spreading manner.

4. The FED as claimed in claim 1, wherein, the cathode electron emitter layers are processed in a screen-printing manner or a spreading manner.

5. The FED as claimed in claim 1, wherein each of the cathode electron emitter layers includes a plurality of property-improving carbon nanotubes (like dotting carbon nanotubes) and has high electron emission efficiency.

6. The FED as claimed in claim 2, wherein the supporting device has a plurality of apertures formed in the reflection layer, and the cathode electron emitter layer is formed on each of the apertures.

7. The FED as claimed in claim 6, further including a plurality of anode ribs disposed between the reflection layer and the anode, and a plurality of passageways formed between the anode ribs and communicating with the apertures, respectively.

8. The FED as claimed in claim 2, wherein the reflection layer is made of aluminum or chromium.

9. The FED as claimed in claim 7, wherein the cathode ribs and the anode ribs are fabricated by photolithography or screen-printing.

10. The FED as claimed in claim 1, further including an adhesive with glass and capable of connecting the anode and the cathode after a sintering process.

11. The FED as claimed in claim 1, wherein the metallic mask has an expansion coefficient ranging from about 10⁻⁶ to 10⁻⁷ per degree centigrade.

12. The FED as claimed in claim 1, wherein the metallic mask has a thickness ranging from about 50 μm to 100 μm.

13. The FED as claimed in claim 1, wherein the metallic mask is made of ferro-nickel alloy materials.

14. The FED as claimed in claim 1, wherein the supporting device has an expansion coefficient ranging from about 82×10⁻⁶ to 86×10⁻⁷ per degree centigrade.
